(19) United States
(12) Patent Application Publication
(10) Pub. No.: US 2006/0241953 A1
(43) Pub. Date: Oct. 26, 2006

(54) Real estate matching by predetermined design

(76) Inventor: Grigory Kravtsov, Yorktown Heights, NY (US)

Correspondence Address: MEREK, BLACKMON & VOORHEES, LLC, 673 S. WASHINGTON ST., ALEXANDRIA, VA, 22314, US

(21) Appl. No.: 11/110,729

(22) Filed: Apr. 21, 2005

(51) Int. Cl. G06Q 99/00

(52) U.S. Cl. 705/1

(57) ABSTRACT

A method of matching buyers and sellers of real estate with specific, predetermined designs for alteration, reconstruction, and renovation of a seller's property with a buyer's requirements. The method includes reviewing property by a skilled home designer for possible modifications to make the property more desirable to potential buyers. Creating a database for listing the property and including in the database potential possible alterations to the property taking into account local zoning laws and regulations. The possible alterations are grouped together based upon total floorspace, potential cost, potential resale value as well as different architectural styles. The buyer's requirements would consist of new or existing designs which would be compared to the database of property listed for sale.

### FIELD OF THE INVENTION

This invention relates to a method of buying and selling real estate.

### BACKGROUND OF THE INVENTION

Most of the desirable land around major metropolitan areas are no longer available for new construction. Therefore, a new buyer coming into the market has to look for existing property which either corresponds to his specifications or would be renovated or rebuilt. Similarly, a prospective seller of an existing property has to market the property as-is or provide a price reduction based upon required future renovation.

The present system of listing real estate on the seller's side and presenting real estate for potential buyers is also currently limited to the actual condition of the property. This system is inefficient for sellers and buyers since the property's potential to meet a buyer's demand requires virtually an exact match. The property listing could reach more potential buyers if alternate possibilities for meeting a buyer's desires were available. Unfortunately, under the current system, real estate agents and homebuyers are not generally capable of knowing the possible alterations to an existing property and therefore the needs of a potential buyer cannot be met by the listing of the existing property.

Therefore, it can be seen that there is a need for a new method of listing real estate for sale which can offer to a potential buyer properties that can meet the buyer's requirements through custom renovation of an existing property. Such a method greatly broadens the scope of possibilities for both the buyer and seller and thus creating a more efficient marketplace by making the database of potential designs available.

### OBJECTS OF THE INVENTION

An object of the invention is to provide a new method for buying and selling real estate.

Another object of the invention is to provide a new method of advertising real estate.

Yet another object of the invention is to provide a new method of financing real estate.

These and other objects of the present invention will become apparent upon review of the following specification and drawings.

### SUMMARY OF THE INVENTION

A method of matching buyers and sellers of real estate with specific, predetermined designs for alteration, reconstruction, and renovation of a seller's property with a buyer's requirements. The method includes reviewing property by a skilled home designer for possible modifications to make the property more desirable to potential buyers. A database is then created for listing the property. The database should also include potential possible alterations to the property taking into account local zoning laws and regulations. The possible alterations are grouped together based upon total floor space, potential cost, potential resale value as well as different architectural styles. The buyer's requirements would consist of new or existing designs which would be compared to the database of property listed for sale.

### BRIEF DESCRIPTION OF THE DRAWINGS

FIG. 1 is a flow chart showing a method of buying and selling real estate.

FIG. 2 is a flow chart showing the financial process of real estate investment.

### DETAILED DESCRIPTION OF THE INVENTION

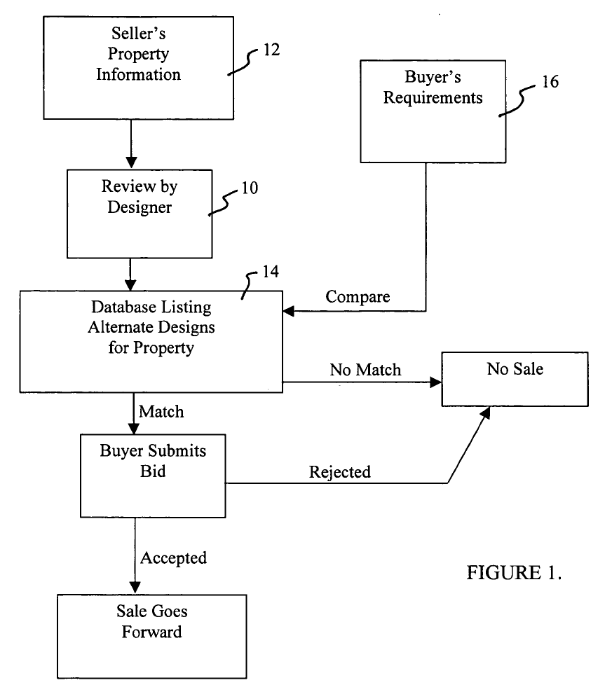

In order to facilitate buying and selling of real estate, an online searchable database 10 as shown in FIG. 1 is created which contains sellers' property information 12, i.e. the listing, and also includes definite renovation and rebuilding options 14 for the property. The seller initiates the process by contacting the online searchable database 10, which provides the plans to a design consultant who will determine various options for development of the property and then provide these options to the seller. The seller may chose to list as many variables and architectural styles as are permitted under the local zoning laws or other considerations such as limited by lot size, etc. The database presents the property information in various groups by location, floor space, architectural style, price, etc.

The database would also include buyers' information 16 including, by way of example, desired location, desired architectural style, building materials, required floor space and price range. Other factors such as handicap accessibility could also be included. The system would include search menus having lists of common search items, i.e. fireplace, number of bedrooms, location such as neighborhood, or oceanfront, rural, etc. thus allowing buyers to search for specific features and combinations of features.

By comparing the sellers' advertised properties with the buyers' requests, the method broadens the scope of possible matches. The system would include a forum for potential buyers to submit offers to sellers. The forum would allow other buyers and sellers to view offers and thereby facilitate bidding and allow other sellers to adjust asking prices based upon market conditions.

The information would preferably be available on the internet, but could also be distributed separately or simultaneously through newspapers, brochures, booklets and in advertising such as labels on cartons and bottles. In the case of label advertising, for instance, a bottled water label could be used to include a listing of the property. The seller could specify the number of bottles and geographical locations to display the ads thus targeting a specific area.

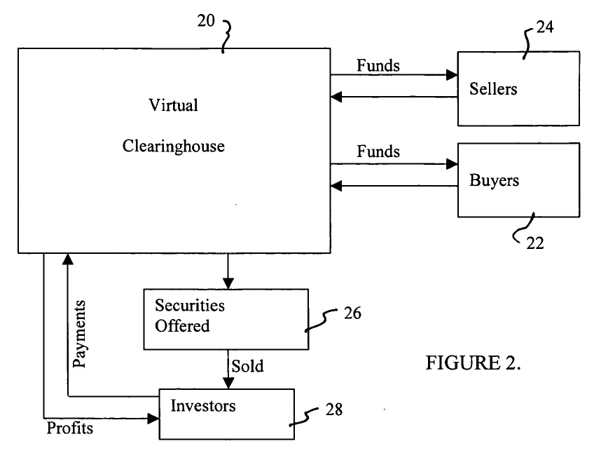

To assist in financing construction and renovation of properties, a financial structure as shown in FIG. 2 is created by a virtual clearinghouse or virtual stock exchange for specific projects and transactions. Since the seller and the buyer may not have sufficient personal funds to finance the renovations, rather than getting a traditional construction loan or bridge loan, a financial structure would be available to the buyer or the seller that is financed by investors through customized matching and direct financing. Private securities such as bonds would be issued using the underlying property as collateral. These bonds would be available for purchase by either by the general public or limited private investors, thus spreading the risk in the short term and allowing the investors to reap the benefits of future increase in value of the property. This process would include wide publication and circulation of the proposed sale and remodeling or renovation of the property through a securities offering which would promote the value of the property to reach its full potential. Through the bidding processes of the homebuyers for the properties as well the bidding process of the securities buyers the value of the properties and the securities will increase. Thus price optimization is reached through spreading of risk.

This financial structure would eliminate the need for mortgage brokers and real estate brokers when selling and purchasing properties. Instead an escrow holding agent is created with the legal powers of a financial agent or attorney to be able to hold pre-payments and release funds to the seller if the transaction is completed or return funds to buyer if the transaction is cancelled.

In addition to the financial structure noted above, an open public exchange is created to maximize the price of the property to the seller and then create a bidding forum for architects, developers and contractors to obtain the best price for the buyer for the actual construction so that through an open online bidding process, the property can be remodeled at the lowest cost to the buyer. The bidding process could include specifications that the architects, developers and contractors must meet, or they could provide their own specifications in an open forum.

While this invention has been described as having a preferred method, it is understood that it is capable of further modifications, uses and/or adaptations of the invention following in general the principle of the invention and including such departures from the present disclosure as come within the known or customary practice in the art to which the present invention pertains and as maybe applied to the central features hereinbefore set forth, and fall within the scope of the invention and the limits of the appended claims.

1. A method of advertising and selling real estate comprising the steps of:
a) creating predetermined custom designs for reconstruction of an existing property, and
b) posting a listing to inform potential buyers of existing property and predetermined custom designs for reconstruction of existing property.

2. The method as set forth in claim 1 wherein;
a) said predetermined custom designs include a new custom built home design and a custom re-built home design.

3. The method as set forth in claim 1, wherein;
a) said posting is included as part of an online forum having a real estate search service.

4. The method as set forth in claim 3, wherein;
a) creating a menu of input selections for a home buyer to choose from whereby said buyer makes selections from said menu and then selects a search function and said search function reviews buyer's selections and compares said selections to information contained in said listings.

5. The method as set forth in claim 4, wherein;
a) said search function determines whether said buyer's selections match said information contained in said listings and provides a list of any matches which occur.

6. The method as set forth in claim 1, further wherein:
a) said posting is included on labels of drink containers.

7. The method as set forth in claim 3, further comprising:
a) an online bidding forum where potential buyers can bid on properties listed.

8. The method as set forth in claim 7, wherein:
a) said online bidding forum is an open forum where all outstanding bids can be viewed by other potential buyers.

9. A method of financing real estate transactions, comprising:
a) creating an online clearinghouse which provides information for real estate investors;
b) providing an online bidding process to allow investors to bid on securities which finance real estate transactions;
c) using proceeds from the sale of said securities to finance real estate reconstruction.

10. The method as set forth in claim 9, wherein:
a) said online clearinghouse includes information for builders and a forum for said builders to bid on remodeling real estate projects.

11. The method as set forth in claim 9, wherein:
a) said online clearinghouse includes an escrow agent for receiving payments from investors and distributing funds to sellers and buyers.
